(19) United States
(12) Patent Application Publication
(10) Pub. No.: US 2009/0138866 A1
(43) Pub. Date: May 28, 2009

(54) UPGRADE PROCESS SYSTEM AND METHOD

(76) Inventors: Michel VEILLETTE, Waterloo (CA); Patrick LeBlanc, Marieville (CA)

Correspondence Address: King and Spalding LLP (Trilliant);Trilliant Customer Number, 1700 Pennsylvania Avenue, NW, Suite 200, Washington, DC, 20006, US

(21) Appl. No.: 12/275,249

(22) Filed: Nov. 21, 2008

Related U.S. Application Data
(60) Provisional application No. 60/989,957, filed on Nov. 25, 2007.
(60) Provisional application No. 60/989,967, filed on Nov. 25, 2007.
(60) Provisional application No. 60/989,958, filed on Nov. 25, 2007.
(60) Provisional application No. 60/989,964, filed on Nov. 25, 2007.
(60) Provisional application No. 60/989,950, filed on Nov. 25, 2007.
(60) Provisional application No. 60/989,953, filed on Nov. 25, 2007.
(60) Provisional application No. 60/989,970, filed on Nov. 25, 2007.
(60) Provisional application No. 60/989,975, filed on Nov. 25, 2007.
(60) Provisional application No. 60/989,959, filed on Nov. 25, 2007.
(60) Provisional application No. 60/989,961, filed on Nov. 25, 2007.
(60) Provisional application No. 60/989,962, filed on Nov. 25, 2007.
(60) Provisional application No. 60/989,951, filed on Nov. 25, 2007.
(60) Provisional application No. 60/989,955, filed on Nov. 25, 2007.
(60) Provisional application No. 60/989,952, filed on Nov. 25, 2007.
(60) Provisional application No. 60/989,954, filed on Nov. 25, 2007.
(60) Provisional application No. 60/992,312, filed on Dec. 4, 2007.
(60) Provisional application No. 60/992,313, filed on Dec. 4, 2007.
(60) Provisional application No. 60/992,315, filed on Dec. 4, 2007.
(60) Provisional application No. 61/025,279, filed on Jan. 31, 2008.
(60) Provisional application No. 61/025,270, filed on Jan. 31, 2008.
(60) Provisional application No. 61/025,276, filed on Jan. 31, 2008.
(60) Provisional application No. 61/025,282, filed on Jan. 31, 2008.
(60) Provisional application No. 61/025,271, filed on Jan. 31, 2008.
(60) Provisional application No. 61/025,287, filed on Jan. 31, 2008.
(60) Provisional application No. 61/025,278, filed on Jan. 31, 2008.
(60) Provisional application No. 61/025,273, filed on Jan. 31, 2008.
(60) Provisional application No. 61/025,277, filed on Jan. 31, 2008.
(60) Provisional application No. 61/094,116, filed on Sep. 4, 2008.

(51) Int. Cl. G06F 9/44; G06F 11/00; H04B 7/00

(52) U.S. Cl. 717/168; 711/162; 455/41.2

(57) ABSTRACT

Firmware, software, or data of a target device may be upgraded by a head end system using one or more of a plurality of systems and methods adapted to upgrade the target device in a variety of different network topologies.

### CROSS-REFERENCE TO RELATED APPLICATIONS

This application claims the benefit of priority to the following U.S. provisional patent applications which are incorporated herein by reference in their entirety:
Ser. No. 60/989,957 entitled “Point-to-Point Communication within a Mesh Network”, filed Nov. 25, 2007 (TR0004-PRO);
Ser. No. 60/989,967 entitled “Efficient And Compact Transport Layer And Model For An Advanced Metering Infrastructure (AMI) Network,” filed Nov. 25, 2007 (TR0003-PRO);
Ser. No. 60/989,958 entitled “Creating And Managing A Mesh Network Including Network Association,” filed Nov. 25, 2007 (TR0005-PRO);
Ser. No. 60/989,964 entitled “Route Optimization Within A Mesh Network,” filed Nov. 25, 2007 (TR0007-PRO);
Ser. No. 60/989,950 entitled “Application Layer Device Agnostic Collector Utilizing ANSI C12.22,” filed Nov. 25, 2007 (TR0009-PRO);
Ser. No. 60/989,953 entitled “System And Method For Real Time Event Report Generation Between Nodes And Head End Server In A Meter Reading Network Including From Smart And Dumb Meters,” filed Nov. 25, 2007 (TR0010-PRO);
Ser. No. 60/989,970 by Michel Veillette entitled “UPGRADE PROCESS SYSTEM AND METHOD” filed Nov. 25, 2007 (TR0013-PRO);
Ser. No. 60/989,975 entitled “System and Method for Network (Mesh) Layer And Application Layer Architecture And Processes,” filed Nov. 25, 2007 (TR0014-PRO);
Ser. No. 60/989,959 entitled “Tree Routing Within a Mesh Network,” filed Nov. 25, 2007 (TR0017-PRO);
Ser. No. 60/989,961 entitled “Source Routing Within a Mesh Network,” filed Nov. 25, 2007 (TR0019-PRO);
Ser. No. 60/989,962 entitled “Creating and Managing a Mesh Network,” filed Nov. 25, 2007 (TR0020-PRO);
Ser. No. 60/989,951 entitled “Network Node And Collector Architecture For Communicating Data And Method Of Communications,” filed Nov. 25, 2007 (TR0021-PRO);
Ser. No. 60/989,955 entitled “System And Method For Recovering From Head End Data Loss And Data Collector Failure In An Automated Meter Reading Infrastructure,” filed Nov. 25, 2007 (TR0022-PRO);
Ser. No. 60/989,952 entitled “System And Method For Assigning Checkpoints To A Plurality Of Network Nodes In Communication With A Device Agnostic Data Collector,” filed Nov. 25, 2007 (TR0023-PRO);
Ser. No. 60/989,954 entitled “System And Method For Synchronizing Data In An Automated Meter Reading Infrastructure,” filed Nov. 25, 2007 (TR0024-PRO);
Ser. No. 60/992,312 entitled “Mesh Network Broadcast,” filed Dec. 4, 2007 (TR0027-PRO);
Ser. No. 60/992,313 entitled “Multi Tree Mesh Networks”, filed Dec. 4, 2007 (TR0028-PRO);
Ser. No. 60/992,315 entitled “Mesh Routing Within a Mesh Network,” filed Dec. 4, 2007 (TR0029-PRO);
Ser. No. 61/025,279 entitled “Point-to-Point Communication within a Mesh Network”, filed Jan. 31, 2008 (TR0030-PRO);
Ser. No. 61/025,270 entitled “Application Layer Device Agnostic Collector Utilizing Standardized Utility Metering Protocol Such As ANSI C12.22,” filed Jan. 31, 2008 (TR0031-PRO);
Ser. No. 61/025,276 entitled “System And Method For Real-Time Event Report Generation Between Nodes And Head End Server In A Meter Reading Network Including From Smart And Dumb Meters,” filed Jan. 31, 2008 (TR0032-PRO);
Ser. No. 61/025,282 entitled “Method And System for Creating And Managing Association And Balancing Of A Mesh Device In A Mesh Network,” filed Jan. 31, 2008 (TR0035-PRO);
Ser. No. 61/025,271 entitled “Method And System for Creating And Managing Association And Balancing Of A Mesh Device In A Mesh Network,” filed Jan. 31, 2008 (TR0037-PRO);
Ser. No. 61/025,287 entitled “System And Method For Operating Mesh Devices In Multi-Tree Overlapping Mesh Networks”, filed Jan. 31, 2008 (TR0038-PRO);
Ser. No. 61/025,278 entitled “System And Method For Recovering From Head End Data Loss And Data Collector Failure In An Automated Meter Reading Infrastructure,” filed Jan. 31, 2008 (TR0039-PRO);
Ser. No. 61/025,273 entitled “System And Method For Assigning Checkpoints to A Plurality Of Network Nodes In Communication With A Device-Agnostic Data Collector,” filed Jan. 31, 2008 (TR0040-PRO);
Ser. No. 61/025,277 entitled “System And Method For Synchronizing Data In An Automated Meter Reading Infrastructure,” filed Jan. 31, 2008 (TR0041-PRO);
Ser. No. 61/094,116 entitled “Message Formats and Processes for Communication Across a Mesh Network,” filed Sep. 4, 2008 (TR0049-PRO).

This application hereby references and incorporates by reference each of the following U.S. patent applications filed contemporaneously herewith:
Ser. No. ______ entitled “Point-to-Point Communication within a Mesh Network”, filed Nov. 21, 2008 (TR0004-US);
Ser. No. ______ entitled “Efficient And Compact Transport Layer And Model For An Advanced Metering Infrastructure (AMI) Network,” filed Nov. 21, 2008 (TR0003-US);
Ser. No. ______ entitled “Communication and Message Route Optimization and Messaging in a Mesh Network,” filed Nov. 21, 2008 (TR0007-US);
Ser. No. ______ entitled “Collector Device and System Utilizing Standardized Utility Metering Protocol,” filed Nov. 21, 2008 (TR0009-US);
Ser. No. ______ entitled “Method and System for Creating and Managing Association and Balancing of a Mesh Device in a Mesh Network,” filed Nov. 21, 2008 (TR0020-US); and
Ser. No. ______ entitled “System And Method For Operating Mesh Devices In Multi-Tree Overlapping Mesh Networks”, filed Nov. 21, 2008 (TR0038-Us).

### FIELD OF THE INVENTION

This invention pertains to systems, devices, and methods for changing and/or upgrading computer program software and/or firmware in a device.

### BACKGROUND

In a network of automated metering devices, displays, demand response devices and other devices, (“target devices”) firmware of the target devices may need to be changed and/or upgraded. A head end server communications system in control of such a network may or may not be in direct communication with a target device.

Where the head end is not in direct communication with the target device, direct upgrade of a plurality of target devices may be impractical if not impossible. In some cases a large number of devices may require simultaneous upgrading, however, direct upgrades from the head end server to the individual devices may not be possible because of limited resources at the head end system.

Further, in some cases, a network may have intermittent coverage or may not even exist between a target device and the head end. Such a target device may not be capable of being upgraded by the head end remotely because the target device may not consistently communicate with the head end. In such instances, the target device may still require upgrades. In addition, direct upgrade of one or more target devices from the head end may be cost ineffective in terms of bandwidth and byte count on the wireless Wide Area Network (WWAN or cellular WAN) link. Subscription rates for a cellular data account typically consider the amount of data bytes exchanged on a monthly basis.

There is therefore a need for systems and methods for providing an upgrade to a target device directly, via an intermediary device, or via a remote device able to upgrade a target device having intermittent or non-existent network access.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above described problems have been reduced or eliminated, while other embodiments are directed to other improvements.

In another non-limiting aspect there may be provided a system comprising: a target device having a dual memory image including a first memory image and a second memory image; a mesh gate in communication with the target device; and a head end server in communication with the mesh gate.

In another non-limiting aspect there may be provided a method comprising: receiving an upgrade from a head end; providing the upgrade to a target device; applying the upgrade to a second memory image; ceasing execution of instructions included in a first memory image; and executing instructions stored in the second memory image. In such non-limiting aspect, for example, the second memory image is copied over the first memory image (i.e., now the “upgraded” first memory image) and then executed. In such aspect, the target device initially executes code from a primary image bank. Thereafter, the target device receives and stores the incoming upgrade file into a secondary memory image bank. When the download is complete, the target device verifies the integrity of the image stored in the secondary memory bank, and then copies the secondary image over the primary memory image bank (i.e. overwrite). When the copy is complete and the integrity of the copy has been validated, the target device reboots into the primary image, and at the end of the process, the upgrade image is present in both the primary and secondary memory banks.

In another non-limiting aspect there may be provided a system comprising: a head end server or server system; a portable upgrade unit; and a target device; wherein, in operation: the head end provides an upgrade associated with the target device to the portable upgrade unit; the portable upgrade unit identifies the target device in local radio frequency (RF) communication with the portable upgrade unit; the portable upgrade unit enters into local radio communication with the target device; and the portable upgrade unit provides the upgrade associated with the target device.

In another non-limiting aspect there may be provided a method comprising: performing a scan of a plurality of radios in a local radio range; identifying a target device in the local radio range; entering into point-to-point communication with the target device; and providing an upgrade and authorization token to the target device.

In another non-limiting aspect there may be provided a system comprising: a head end server or server system; an automated metering device in radio communications with the head end via a radio service; wherein, in operation: the head end identifies firmware of the automated metering device as requiring a change or an upgrade; the head end provides a firmware upgrade to the automated metering device via the radio communications over the radio service; and the automated metering device receives and installs the upgrade.

In another non-limiting aspect there may be provided a computer program stored in a computer readable form for execution in a processor and a processor coupled memory to implement a method comprising: receiving an upgrade from a head end server; providing the upgrade to a target device; applying the upgrade to a second memory image; ceasing execution of instructions included in a first memory image; and executing instructions stored in the second memory image. For example, in such non-limiting aspect, the second memory image is copied over the first memory image (i.e., now the “upgraded” first memory image) and then executed. In such aspect, the target device initially executes code from a primary image bank. Thereafter, the target device receives and stores the incoming upgrade file into a secondary memory image bank. When the download is complete, the target device verifies the integrity of the image stored in the secondary memory bank, and then copies the secondary image over the primary memory image bank (i.e. overwrite). When the copy is complete and the integrity of the copy has been validated, the target device reboots into the primary image, and at the end of the process, the upgrade image is present in both the primary and secondary memory banks.

In another non-limiting aspect there may be provided a computer program stored in a computer readable form for execution in a processor and a processor coupled memory to implement a method comprising: performing a scan of all radios in a local radio range; identifying a target device in the local radio range; entering into point-to-point communication with the target device; and providing an upgrade and authorization token to the target device.

In another non-limiting aspect there may be provided a system for upgrading an external target device with an upgrade software or firmware from an external source, the system comprising: a portable upgrade unit configured to: (i) receive an upgrade software or firmware associated with the target device from the external source; (ii) identify the target device in local radio frequency (RF) communication with the portable upgrade unit; (iii) enter into local radio communication with the target device; and (iv) communicate the upgrade associated with the target device to the target device.

This Summary introduces concepts in a simplified form that are described more fully below in the Detailed Description. This Summary is not intended to identify key or essential features of the claimed subject matter, nor is it intended to be used to limit the scope of the claimed subject matter.

### BRIEF DESCRIPTION OF THE DRAWINGS

FIG. 1 depicts a diagram of a first example system for upgrading a target device.

FIG. 2 depicts a diagram of a second example system for upgrading a target device.

FIG. 3 depicts a flowchart of an example method for upgrading a target device.

FIG. 4 depicts a diagram of an example system for upgrading a target device.

FIG. 5 depicts a flowchart of an example method for upgrading a target device.

FIG. 6 depicts a diagram of an example system for upgrading a target device.

FIG. 7 depicts a flowchart of an example method for upgrading a target device.

FIG. 8 depicts a diagram of an example system including a plurality of potential target devices.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

A technique for upgrading a target device may be implemented in one or more systems for direct, indirect, or remote upgrading. In the case of a direct upgrade, a head end may provide the upgrade directly to the target device via a network.

For an indirect upgrade, a neighborhood area network to wide area network (NAN-WAN) gate communicating in one or more protocols may upgrade one or more target devices. Upgrades received at the NAN-WAN gate from a head end may be retransmitted by the NAN-WAN gate to one or more individual target devices. Advantageously, the head end unit is relieved of the duty of directly providing the update to a plurality of individual target devices.

A remote upgrade may involve a portable upgrade device. The portable upgrade device may initially be in communication with a head end system to receive the upgrade as well as related items. Once in the local range of the target device, the portable upgrade unit may enter into direct communication with the target device and provide the upgrade.

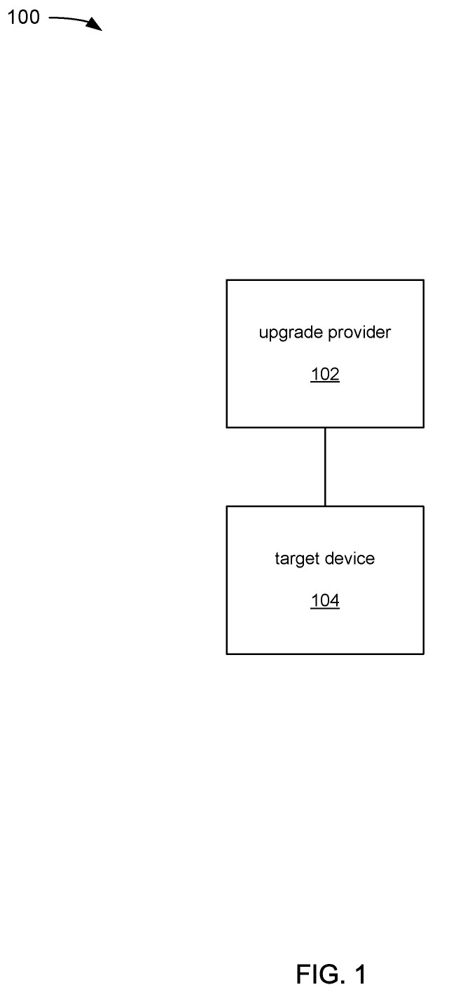

FIG. 1 depicts a diagram of an exemplary system 100 for upgrading a target device. Exemplary system 100 includes upgrade provider 102 and target device 104.

Upgrade provider 102 may be a head end system, a NAN-WAN gate, a combination of the head end system and the NAN-WAN gate, a remote tool, or any known or convenient system or device for communicating with a target device.

The target device 104 may be any device requiring a software, data, or firmware upgrade. In a non-limiting example, a meter attached to a communications unit includes firmware that requires upgrading. Similarly, the target device 104 could be a thermostat, a pool pump, an in home display, or any known or convenient target device.

In the example of FIG. 1, in operation, the upgrade provider 102 provides the upgrade to the target device 104. The upgrade may include firmware, software, or data. In connection with receiving the upgrade, the target device 104 may also receive an authorization token from the upgrade provider 102 confirming that it is an approved upgrade.

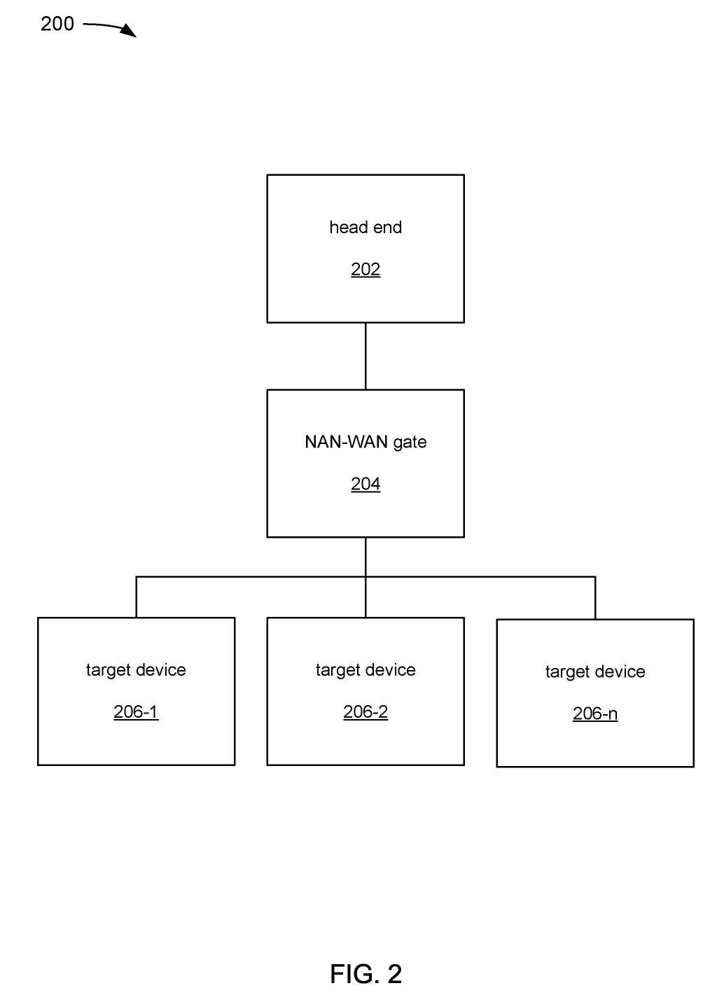

FIG. 2 depicts a diagram of an exemplary system 200 for upgrading a target device. Exemplary system 200 includes head end 202, NAN-WAN gate 204, target device 206-1, target device 206-2, and target device 206-n (collectively target devices 206). The head end 202 may include one or more computing devices capable of communicating with one or more NAN-WAN gates or other mesh gates.

In the example of FIG. 2, in operation, the head end 202 provides an upgrade to the NAN-WAN gate 204, and the NAN-WAN gate 204 redistributes the upgrade to the target devices 206 in a broadcast of the upgrade. It is not necessary that there be a plurality of target devices to upgrade or that there be a broadcast of the upgrade; a single device may be upgraded.

Advantageously, where a significant number of devices are to be upgraded, and multiple NAN-WAN gates are implemented, the head end 202 may be relieved of providing the upgrade to the plurality of target devices, and may merely distribute the upgrade to a plurality of NAN-WAN gates.

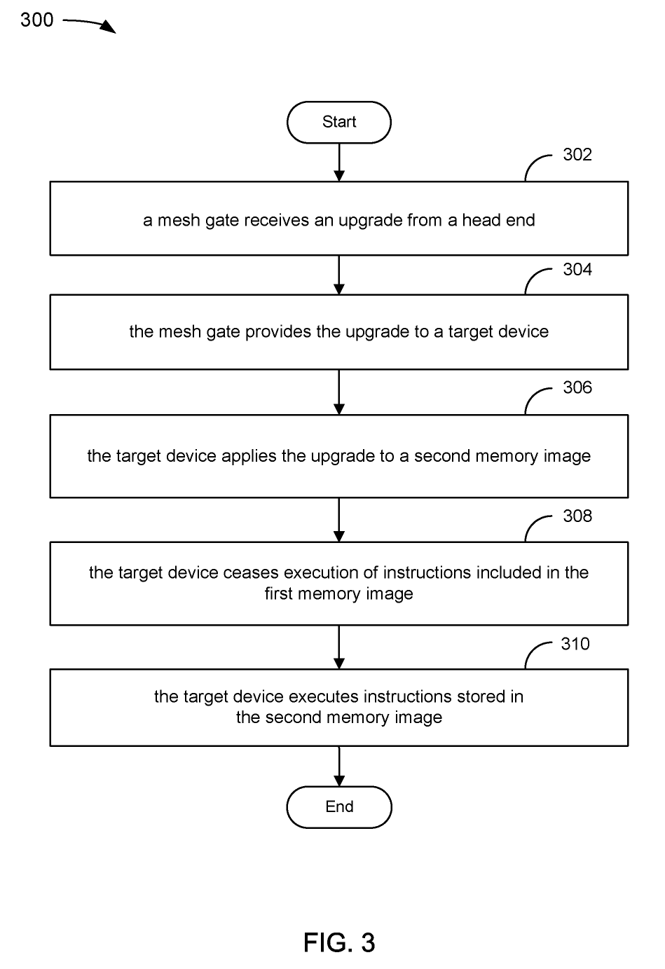

FIG. 3 depicts a flowchart of an exemplary method 300 for upgrading a target device. The method 300 is organized as a sequence of modules or steps in the flowchart. However, it should be understood that these exemplary steps or modules may be associated with other methods described herein and may be reordered for parallel execution or into different sequences of steps or modules.

In the example of FIG. 3, the method provides for the transmission of an upgrade from a head end to a mesh gate such as a NAN-WAN gate in exemplary step 302. In step 304, the mesh gate provides the upgrade to a target device. The target device may include two memory images, and may operate on a first memory image. In step 306, the upgrade may be applied to the second memory image. In steps 308 and 310, the target device may cease execution of the instructions stored in the first memory image and begin execution of the instructions stored in the second memory image. Optionally but advantageously, the target device need not cease operation during the upgrade.

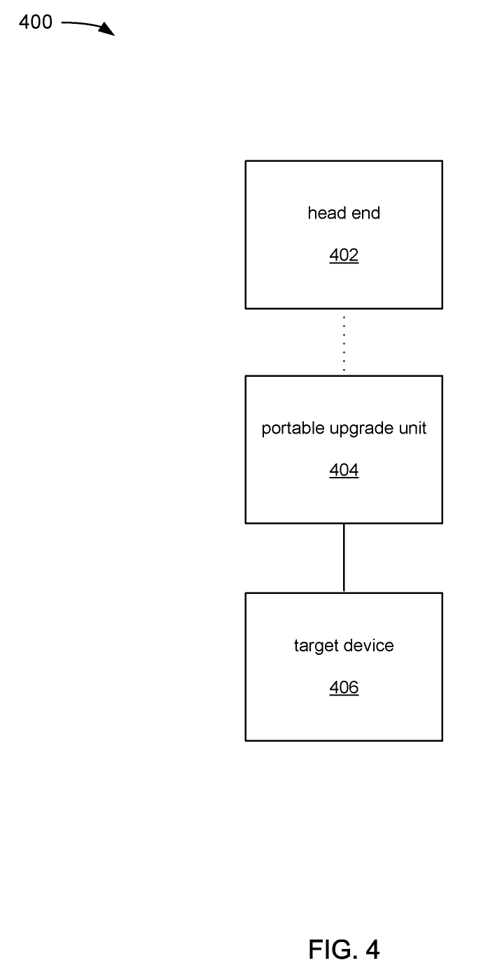

FIG. 4 depicts a diagram of an exemplary system 400 for upgrading a target device. Exemplary system 400 includes a head end 402, a portable upgrade unit 404, and a target device 406.

In the example of FIG. 4, in operation, the head end 402 and the portable upgrade unit 404 are in communication either locally, or via a network. While connected, the head end 402 provides an upgrade to the portable upgrade unit 404. The portable upgrade unit 404 may then optionally disconnect from the head end 402. The portable upgrade unit 404 may then be transported to within the local area of the target device 406. The portable upgrade unit may enter into local communication with the target device 406 and perform the upgrade. Advantageously, any network communication issues between the head end and the target device will not prevent the portable upgrade unit from providing the upgrade to the target device.

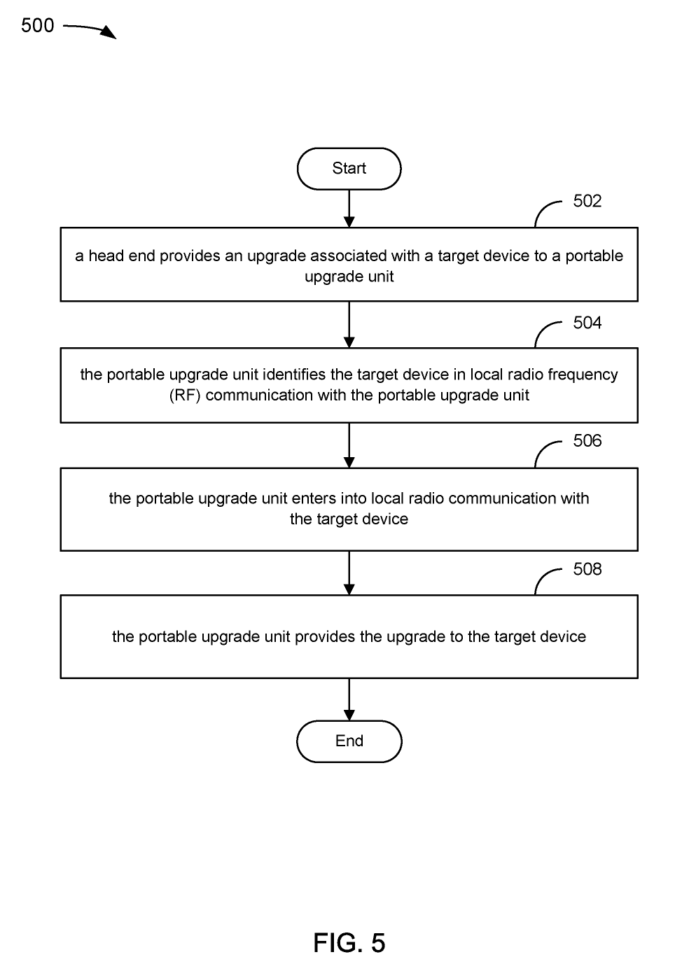

FIG. 5 depicts a flowchart of an exemplary method 500 for upgrading a target device. The method 500 is organized as a sequence of modules or steps in the flowchart. However, it should be understood that these steps or modules may be associated with other methods described herein and may be reordered for parallel execution or into different sequences of steps or modules.

In step 502 of the example of FIG. 5, a head end enters into either local or network communication with a portable upgrade unit, and provides the upgrade to the portable upgrade unit. The portable upgrade unit may then optionally be transported to the local area of a target device. In step 504, the portable upgrade unit 404 identifies the target device in local radio frequency communication with the portable upgrade unit. The portable upgrade unit may enter into local communication with the target device and provide the upgrade in steps 506 and 508.

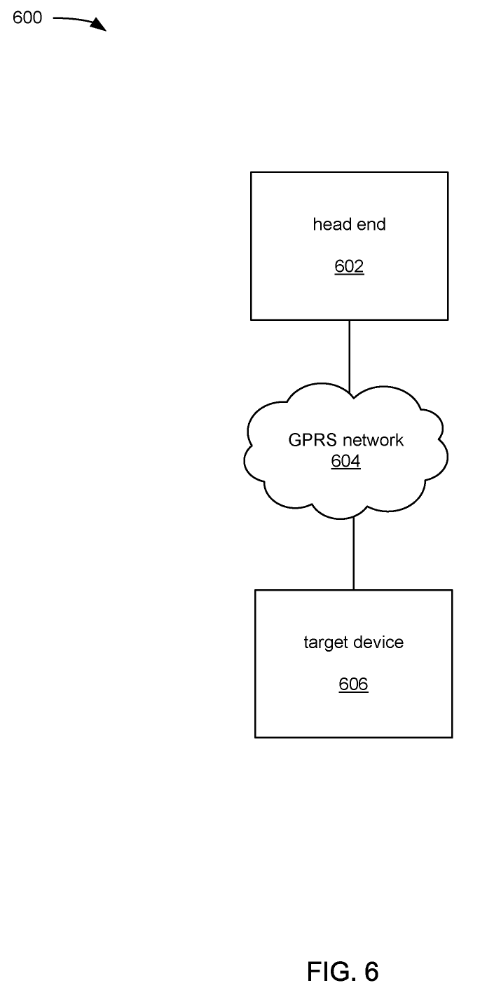

FIG. 6 depicts a diagram of an exemplary system 600 for upgrading a target device. Exemplary system 600 includes head end 602, general packet radio service (GPRS) network 604, and target device 606. It is to be understood that references herein to GPRS network in terms of the wireless Wide Area Network (WWAN) are not limiting and that embodiments of the invention support any other WWAN technologies including, without limitation, 1xRTT (also known as CDMA2000 1xRTT, 1x, and IS-2000) and Integrated Digital Enhanced Network (iDEN). It is to be further understood that the mesh gate employed in embodiments of the invention is provided with an Ethernet port which enables hooking up to numerous types of external communication modems, such as Wifi, WiMax, Canopy and others.

In the example of FIG. 6, in operation, the head end transmits an upgrade over the GPRS network to the target device. The target device receives and implements the upgrade.

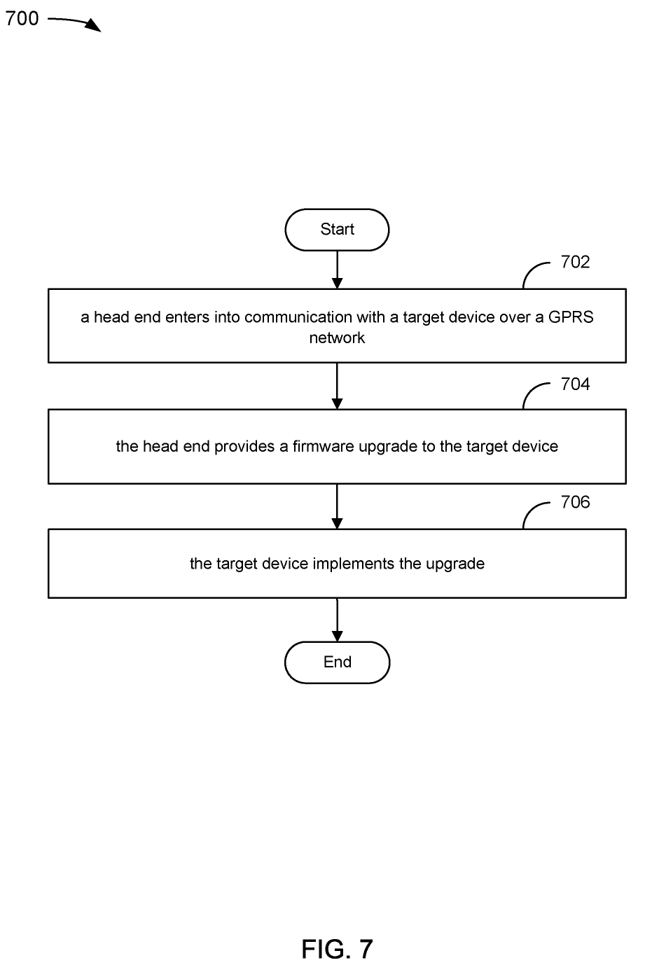

FIG. 7 depicts a flowchart of an exemplary method 700 for upgrading a target device. The method 700 is organized as a sequence of modules or steps in the flowchart. However, it should be understood that these steps and modules may be associated with other methods described herein and may be reordered for parallel execution or into different sequences of modules or steps. Optionally, but advantageously, an existing GPRS network (or similar system) may be implemented for areas where a mesh network cannot be or has not been implemented.

In the example of FIG. 7, a head end enters into communication with a target device over a radio network, such as over a GPRS network in step 702. Once communication is established in step 704, the head end provides an upgrade to the target device over the GPRS network. The upgrade may include, but is not limited to software, firmware and data. In step 706, the target device implements the upgrade.

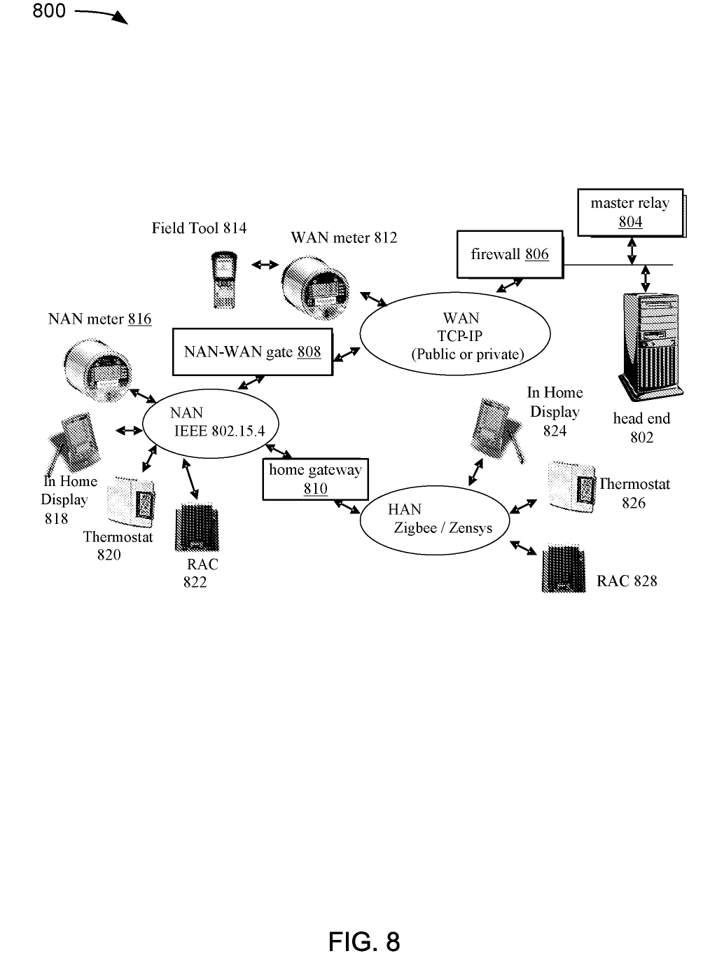

FIG. 8 depicts a diagram of an exemplary system 800 including a plurality of potential target devices. FIG. 8 includes head end 802, master relay 804, firewall 806, Neighborhood Area Network (NAN) meter 816, home gateway 810, wide area network (WAN) meter 812, field tool 814, Neighborhood Area Network to Wide area Network (NAN-WAN) gate 808, in home display 818, thermostat 820, and remote appliance controller (RAC) 822, in home display 824, thermostat 826, and RAC 828.

The head end 802 is typically a computing device that may include a suite of applications including functionality for an acquisition system, real-time data access, device management, network management, and other known or convenient functionality.

The master relay 804 may keep track of locations of different target devices as well as other devices.

The firewall 806 may provide protection to the master relay 804 and the head end 802 from other devices. In a non-limiting embodiment, a TCP-IP-based firewall may be used to insulate the head end 802 and the master relay 804. The head end 802 and the master relay 804 may communicate with other networks via a WAN using TCP-IP as illustrated in the exemplary system 800.

The NAN-WAN gate 808 may include an IEEE 802.15.4 PAN Coordinator, an ANSI C12.22 Relay, a device collecting messages from multiple units on the NAN and a firewall.

The home gateway 810 may be a gateway in the sense that a protocol used by devices connected to the home gateway 810 use a different protocol than the NAN-WAN gate 808 uses to connect to the NAN meter 816. In a non-limiting example, ZigBee, Z-Wave, or X-8 communication protocols may be used by the devices connected to the home gateway 810 whereas the home gateway 810 uses the Trilliant transport protocol to connect to the NAN-WAN gate 808.

The WAN meter 812 may be a device such as a meter including a communications board and a radio directly connected to a wide area network, and then connected back to the head end 802 via the firewall 806 and master relay 804.

The field tool 814 may include a radio as well as a local network connection. The field tool 814 may provide operation and maintenance functions.

The NAN meter 816, the thermostat 820, and the RAC 822 may each include a radio and a processor coupled to a memory storing instructions. The NAN meter 816, the thermostat 820, and the RAC 822 may each communicate with the NAN-WAN gate 808, and may or may not use the TCP/IP protocol.

The in home display 824, the thermostat 826, and the RAC 828 may each include a radio and a processor coupled to a memory storing instructions. The home gateway 810 may each communicate using a protocol other than TCP/IP and other than the Trilliant Transport Protocol. In a non-limiting example, the in home display 824, the thermostat 826, and the RAC 828 each may communicate using the ZigBee, the Z-Wave, the X-8 or another known or convenient protocol.

It will be appreciated to those skilled in the art that the preceding examples and embodiments are exemplary and not limiting in scope. It is intended that all permutations, enhancements, equivalents, and improvements thereto that are apparent to those skilled in the art upon a reading of the specification and a study of the drawings are included within the true spirit and scope of these teachings. It is therefore intended that the following appended claims include all such modifications, permutations, and equivalents as fall within the true spirit and scope of these teachings.

What is claimed is:

1. A system comprising:
a target device having a dual memory image including a first memory image and a second memory image;
a mesh gate in communication with the target device; and
a head end server in communication with the mesh gate.

2. The system of claim 1, wherein the target device is a communications board of a meter.

3. The system of claim 1, wherein the mesh gate and the target device communicate using IEEE 802.15.4.

4. The system of claim 1, wherein the target device is a meshreader, an in home display, a thermostat, a remote appliance controller, a thermostat, or an in-home display.

5. The system of claim 1, wherein the head end and the mesh gate communicate.

6. A method comprising:
receiving an upgrade from a head end via a mesh gate in a mesh network;
applying the upgrade to a second memory image;
ceasing execution of instructions included in a first memory image; and
executing instructions stored in the second memory image.

7. The method of claim 6, wherein providing is accomplished via IEEE 802.15.4.

8. A system comprising:
a head end server or server system;
a portable upgrade unit;
a target device;
wherein, in operation:
the head end provides an upgrade associated with the target device to the portable upgrade unit;
the portable upgrade unit identifies the target device in local radio frequency (RF) communication with the portable upgrade unit;
the portable upgrade unit enters into local radio communication with the target device; and
the portable upgrade unit provides the upgrade associated with the target device.

9. The system of claim 8, further comprising transporting the portable upgrade unit to a site local to the target device.

10. The system of claim 8, wherein the target device is selected from the set consisting of: a meshreader, a thermostat, a remote appliance controller, or an in-home display.

11. A method comprising:
performing a scan of a plurality of radios in a local radio range;
identifying a target device in the local radio range;
entering into point to point communication with the target device; and
providing an upgrade and authorization token to the target device.

12. The method of claim 11, further comprising filtering the scan by network name.

13. A system comprising:
a head end server or server system;
an automated metering device in radio communications with the head end via a radio service;
wherein, in operation:
the head end identifies firmware of the automated metering device as requiring a change or an upgrade;
the head end provides a firmware upgrade to the automated metering device via the radio communications over the radio service; and
the automated metering device receives and installs the upgrade.

14. The system of claim 13, wherein the radio service comprises the general packet radio service (GPRS).

15. The system of claim 13, wherein the head end directly communicates with the automated metering device using the transport control protocol and the internet protocol (TCP/IP).

16. A computer program stored in a computer readable form for execution in a processor and a processor coupled memory to implement a method comprising:
receiving an upgrade from a head end server;
providing the upgrade to a target device;
applying the upgrade to a second memory image;
ceasing execution of instructions included in a first memory image; and
executing instructions stored in the second memory image.

17. A computer program stored in a computer readable form for execution in a processor and a processor coupled memory to implement a method comprising:
performing a scan of all radios in a local radio range;
identifying a target device in the local radio range;
entering into point to point communication with the target device; and
providing an upgrade and authorization token to the target device.

18. A system comprising for upgrading a external target device with an upgrade software or firmware from an external source, the system comprising:
a portable upgrade unit configured to:
(i) receive an upgrade software or firmware associated with the target device from the external source;
(ii) identify the target device in local radio frequency (RF) communication with the portable upgrade unit;
(iii) enter into local radio communication with the target device; and
(iv) communicate the upgrade associated with the target device to the target device.

19. The system of claim 18, further comprising the target device.

20. The system of claim 18, wherein the external source comprises an external server.

21. The system of claim 20, wherein system further comprises the external server.

22. The system of claim 18, further comprising: the target device; and the external source where the external source comprises an external server or server system.
